(19) United States
(12) Patent Application Publication
(10) Pub. No.: US 2007/0104439 A1
(43) Pub. Date: May 10, 2007

(54) Polymer optical waveguide and optical device

(75) Inventors: Kentarou Tamaki, Tokyo (JP); Hideaki Takase, Tokyo (JP); Yuuichi Eriyama, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: JSR CORPORATION, Tokyo (JP)

(21) Appl. No.: 10/558,299

(22) PCT Filed: May 28, 2004
(86) PCT No.: PCT/JP04/07733

§ 371 Date: Aug. 23, 2006

(30) Foreign Application Priority Data
May 28, 2003 (JP) 2003-151594

(51) Int. Cl. G02B 6/10

(52) U.S. Cl. 385/129

(57) ABSTRACT

A polymer optical waveguide of the present invention has a lower clad layer, a core layer and an upper clad layer that are provided on a substrate, and a cover member that covers at least one part of the upper clad layer. The upper clad layer and the cover member are fixed together by a radiation-curable adhesive. The cover member comprises quartz or glass. According to this polymer optical waveguide, moisture absorption through the upper clad layer can be prevented, deterioration in adhesive property to the substrate or changes in characteristics due to moisture absorption of materials can be suppressed even under severe environmental conditions, and there is no deterioration in optical characteristics between before and after reliability tests, and hence sufficient reliability can be secured, and the polymer optical waveguide has stable transmission characteristics.

### TECHNICAL FIELD

The present invention relates to an optical device, and more specifically is characterized by preventing deterioration in optical characteristics with regard to long-term stability of an optical device having a polymer optical waveguide.

The present invention relates to a polymer optical waveguide in which at least one part of an upper clad layer, which is a constituent element of the optical waveguide, is covered by a cover member. More specifically, the present invention relates to a polymer optical waveguide in which the upper clad layer and the cover member are bonded together by a radiation-curable resin, and an optical device having the polymer optical waveguide.

### BACKGROUND ART

As we enter the multimedia age, due to demands to increase the capacity and speed of data processing in optical communication systems and computers, optical waveguides have come to receive attention as light transmission media. It is desirable for optical waveguides used with such an object to have good optical characteristics such as transmission loss and polarization dependence, and to have stable performance over a long period without being affected by the external environment, and moreover to be manufactured in a minute and complex form with good yield in few steps in a short time using little energy, and without polluting the environment.

Hitherto, quartz waveguides have been typical as optical waveguides, but in the manufacture thereof, processing for a long time at a high temperature is required to build up a quartz film, and the waveguide patterning includes a step of using a photoresist and a step of etching using a highly dangerous gas, and hence special apparatus is required. Due to such a state of affairs, there are problems such that there are many complex steps, the manufacture requires a long time despite using special apparatus, and furthermore, the yield is low.

To combat such problems, in recent years there have been proposed several polymer optical waveguides that use liquid curable compositions as the materials of the core portion and the clad portions, with an object of improving productivity, for example shortening the optical waveguide manufacturing time, reducing the number of manufacturing steps, and improving the yield (see Japanese Patent Application Laid-open No. H06-109936, Japanese Patent Application Laid-open No. H10-254140, Japanese Patent Application Laid-open No. 2000-180643).

When polymer optical waveguides are used, there are great cost advantages of simplifying the manufacturing process, shortening the manufacturing time and so on, compared with conventional quartz optical waveguides. But it has been a problem that the properties of polymer materials are worse than those of inorganic materials with regard to moisture absorption and so on. It is known that if moisture is absorbed from the air through an upper clad layer, then there are adverse effects on the transmission characteristics of an optical waveguide.

On the other hand, with regard to quartz optical waveguides, to prevent moisture absorption by a resin adhesive that fixes an optical filter to a part of a clad layer, art is known in which the bonded part is sealed with a quartz plate or the like, but it has not been possible to sufficiently prevent moisture absorption by the clad layer itself in a polymer optical waveguide (see Japanese Patent Application Laid-open No. H9-615151, Japanese Patent Application Laid-open No. H11-52150).

### DISCLOSURE OF THE INVENTION

The present inventors carried out assiduous studies with an object of resolving the problems of the prior art described above, and as a result succeeded in inventing a polymer optical waveguide shown in the present invention. That is, the present invention provides a polymer optical waveguide having a lower clad layer, a core layer and an upper clad layer that are provided on a substrate, and a cover member that covers at least one part of the upper clad layer, whereby moisture absorption through the upper clad layer can be prevented, and hence deterioration in adhesive property to the substrate and unfavorable changes in characteristics due to moisture absorption of materials can be suppressed even under severe environmental conditions, and there is no deterioration in optical characteristics between before and after reliability tests, and hence sufficient reliability can be secured, and stable transmission characteristics can be obtained.

It should be noted that an ‘optical device’ in the present invention is a device in which an inorganic material such as glass or quartz, a semiconductor or metal material such as silicon, gallium arsenide, aluminum or titanium, a polymeric material such as a polyimide or a polyamide, or a composite material thereof is used as a substrate, and an optical waveguide, an optical multiplexer, an optical demultiplexer, an optical multiplexer/demultiplexer, an optical diffracter, an optical amplifier, an optical attenuator, an optical interferer, an optical filter, an optical switch, a wavelength converter, a light emitter or a photo receiver, or a composite thereof is formed on such a substrate. Moreover, a semiconductor device such as a light-emitting diode or a photodiode, or a metal film such as an electrode may be formed on such a substrate, and moreover to protect the substrate or control the refractive index of the substrate, a coating film of silicon oxide, silicon nitride, aluminum oxide, aluminum nitride, tantalum oxide or the like may be formed on the substrate.

The present invention is as follows.

(1) A polymer optical waveguide having a lower clad layer, a core layer and an upper clad layer that are provided on a substrate, and a cover member that covers at least one part of the upper clad layer.

(2) The polymer optical waveguide according to (1) above, wherein the upper clad layer and the cover member are fixed together by a radiation-curable adhesive.

(3) The polymer optical waveguide according to (1) or (2) above, wherein the cover member comprises quartz or glass.

(4) An optical device having the optical waveguide according to any of (1) through (3) above.

According to the present invention, there can be provided an optical waveguide and an optical device for which deterioration in adhesive property to the substrate and unfavorable changes in characteristics due to moisture absorption of materials can be suppressed even under severe environmental conditions, and there is no deterioration in optical characteristics between before and after reliability tests, and hence sufficient reliability can be secured, and moreover working efficiency is good.

### BEST MODE FOR CARRYING OUT THE INVENTION

Following is a concrete description of embodiments of the present invention. ‘Polymer optical waveguide’ in the present invention refers to an optical waveguide in which a lower clad layer, a core layer and an upper clad layer are each formed from a resin such as a cured material of a radiation-curable composition, heat-curable composition or the like. There are no particular limitations on the type of a radiation-curable composition which forms the core layer or clad layers of a polymer optical waveguide of the present invention, but, an example is a radiation-curable composition containing a photosensitive polysiloxane from the viewpoint of optical characteristics and direct light exposure being possible. If the core portion and the clad portions of the optical waveguide are formed from a siloxane-type polymer, then a polymer optical waveguide having excellent heat resistance due to siloxane linkages in the main backbone will be obtained. Moreover, other than a polysiloxane-type composition, a radiation-curable composition mainly based on a photosensitive acrylic monomer or a photosensitive epoxy monomer may be used as a radiation-curable composition used in the present invention. Moreover, instead of a cured material of such a radiation-curable composition, the core layer and the clad layers in the present invention may each be formed from a resin such as a fluorinated polyimide, a polymethyl methacrylate resin, a polycarbonate or the like.

There are no particular limitations on the material of the cover member in the present invention, so long as this material has low moisture permeability; however, from the viewpoints of strength, low coefficient of linear expansion and so on, a sheet of quartz, glass or the like is preferable.

There are no particular limitations on the type of an adhesive for bonding the upper clad layer and the cover member together in the present invention, but from the viewpoints of productivity and room temperature curability, a radiation-curable adhesive is preferable. There are no particular limitations on the type of such a radiation-curable adhesive, but an acrylic-type, epoxy-type or silicone-type one or the like is preferable. Specific examples of commercially sold ones of such radiation-curable adhesives include NOA60, NOA65 and NOA81 (made by Norland), OG114-4 and OG146 (made by EPO-TEK), Three Bond 3160 and Three Bond 3170B (made by Three Bond), AT3925M and AT9575M (made by NTT Advanced Technology), and ELC2710 and ELC2500 Clear (made by Electro-lite).

[Formation of Optical Waveguide]

A description will now be given of an embodiment when forming the optical waveguide, taking an example of manufacturing the optical waveguide through photo-curing.

1. Preparation of Radiation-Curable Compositions for Forming Optical Waveguides

As an optical waveguide-forming composition for forming the clad layers of the optical waveguide, a radiation-curable composition containing a polysiloxane component as described earlier and a photosensitive compound maybe used, or a heat-curable or photo-curable composition may be used.

The composition for forming a lower layer, the composition for forming a core portion, and the composition for forming an upper layer, which are to be prepared, can be selected so that the relationship among the refractive indices of the respective portions ultimately obtained satisfies the conditions required for an optical waveguide, for example, so that the specific refractive index difference is 0.2 to 0.6% and the diameter of a core portion is 5 to 10 μm.

By suitably selecting the type and so on of a hydrolyzable silane compound that is a raw material of a polysiloxane component, radiation-curable compositions for forming an optical waveguide, which give cured films having various refractive indices, can be produced. Moreover, it is preferable to use two or three radiation-curable compositions for forming an optical waveguide such that the refractive index difference will be a value in a suitable range, and use one radiation-curable composition for forming an optical waveguide which can give a cured film having the highest refractive index as the composition for the core portion, and use the other compositions for forming an optical waveguide as the compositions for forming the lower clad layer and the upper clad layer.

It should be noted, however, that the composition for forming an upper clad layer may be the same as the composition for forming a lower clad layer, and in general, using one composition as the materials of these clad layers is preferable since this is economically advantageous and manufacturing management becomes easy.

Moreover, when the compositions for forming the clad layers of the optical waveguide are prepared, the viscosity of the compositions is preferably made to be a value in a range of 100 to 10,000 cps (25° C.), more preferably 100 to 8,000 cps (25° C.), most preferably 300 to 3,000 cps (25° C.).

The reason for this is that if the viscosity of each optical waveguide-forming composition is outside such a range, then handling may become difficult, or it may become difficult to form a uniform coating film.

The viscosity of each optical waveguide-forming composition can be adjusted as appropriate by regulating the amount of a reactive diluent or organic solvent to be added.

2. Formation Method

Following is a description of a process for manufacturing the optical waveguide through a wet lithography method using radiation-curable compositions of the present invention, taking an example of manufacturing a so-called channel-type optical waveguide. It should be noted, however, that there are no particular limitations on the structure of the optical waveguide of the present invention.

An optical waveguide with a cross section having a structure shown in FIG. 1 is formed through steps shown in FIG. 2. That is, a lower clad layer 13, a core portion 15 and an upper clad layer 17 (not shown in FIG.) are each preferably formed by applying an optical waveguide-forming composition for forming that layer, and then heat-curing or photo-curing.

It should be noted that in the following example of forming an optical waveguide, description is given assuming that the lower clad layer, the core portion and the upper clad layer are formed respectively using a composition for forming the lower clad layer, a composition for forming the core portion and a composition for forming the upper clad layer, and these optical waveguide-forming compositions can form portions having different refractive indices each other after curing.

A description will now be given of the method of applying the curable compositions for forming the lower clad layer, the core portions and the upper clad layer of the optical waveguide of the present invention. There are no particular limitations on the application method so long as the surface of the cured film is uniform; a spin coating method, a spraying method, a roll coating method, an ink jet method or the like can be used, but out of these the spin coating method, which is used as a high-precision industrial application technique in the semiconductor industry, is preferable.

Regarding the spin coating conditions, the spin coating comprises a first step of applying the liquid composition uniformly onto a substrate carried out for 1 to 60 seconds at 10 to 1,000 revolutions/minute (hereinafter referred to as ‘rev/min’) in a range of 0 to 100° C., and a second step of forming a film having a constant thickness through high-speed revolution. The second step is dominant in controlling the surface roughness, and moreover the conditions are selected in accordance with the viscosity of the curable liquid composition. In the case that the viscosity of the curable liquid composition is 100 to 3,000 cps, the second step is preferably carried out for 30 to 100 seconds at 500 to 5,000 rev/min, and in the case that the viscosity is 3,000 to 10, 000 cps, the second step is preferably carried out for 60 to 300 seconds at 1,000 to 8,000 rev/min.

(1) Preparation of Substrate

First, as shown in FIG. 2(a), a substrate 12 having a flat surface is prepared.

(2) Step of Forming a Lower Clad Layer

This is a step of forming the lower clad layer 13 on the surface of the prepared substrate 12. Specifically, as shown in FIG. 2(b), the composition for forming the lower clad layer is applied onto the surface of the substrate 12, and dried or prebaked to form a lower layer thin film. The lower layer thin film is then cured by heating or irradiating with light, whereby the lower clad layer 13 can be formed.

There are no particular limitations on the heating temperature used in the formation of the core layer and clad layers, but in general the heating is carried out for 1 minute to 24 hours in a range of 50 to 300° C. Moreover, there are no particular limitations on the types of light, but in general light from the ultraviolet to visible region having a wavelength of 200 to 450 nm, preferably light containing ultraviolet radiation having a wavelength of 365 nm is used. The irradiation is carried out such that the intensity at wavelength of 200 to 450 nm is 1 to 1,000 mW/cm², and the irradiation dose is 0.01 to 5,000 mJ/cm², preferably 0.1 to 1,000 mJ/cm², thus carrying out exposure.

Here, as the type of the irradiated radiation, visible light, ultraviolet radiation, infrared radiation, X-rays, α-rays, β-rays, γ-rays, an electron beam and so on can be used, but due to the industrial versatility of the light source, it is preferable to use light having wavelengths which include a wavelength of ultraviolet radiation, it is more preferable to use light having wavelengths which include a wavelength of 200 to 400 nm, it is most preferable to use light having wavelengths which include a wavelength of 365 nm. Moreover, as the irradiation apparatus, it is possible to use, for example, a lamp light source that irradiates a wide area simultaneously such as a high-pressure mercury lamp, a low-pressure mercury lamp, a metal halide lamp or an excimer lamp, or a laser light source that emits light as pulses or continuously, or light from either of these light sources converged using mirrors, lenses or optical fibers. In the case of forming the optical waveguide using such convergent light, the exposure can be carried out in the shape of the optical waveguide by moving either the convergent light or the irradiated object. Of the above light sources, a light source having a high ultraviolet radiation intensity at 365 nm is preferable, for example a high-pressure mercury lamp as a lamp light source, or an argon laser as a laser light source is preferable. It should be noted that in the step of forming the lower clad layer 13, it is preferable to irradiate the whole of the thin film with light, thus curing the whole of the thin film.

Moreover, to make the Theological properties of the applied composition suitably match the application method, additives other than surface tension-reducing agents may be mixed in as required. Moreover, it is preferable to prebake the film comprising the composition for forming the lower clad layer at a temperature of 50 to 200° C. after the application.

The details of the application method, the improvement of rheological properties and so on in the lower clad layer formation step can be also applied to the core portion formation step and the upper clad layer formation step described below.

Moreover, after the exposure, to cure the whole of the coating film sufficiently, it is preferable to carry out heating treatment furthermore (hereinafter referred to as ‘post-baking’). The heating conditions will vary with the composition of the optical waveguide-forming composition, the types of additives and so on, but it is generally preferable to make the heating conditions be, for example, 5 minutes to 72 hours at 30 to 400° C., preferably 50 to 300° C.

The details of the irradiation dose and the type of the light, the irradiation apparatus and so on in the lower clad layer formation step can be also applied to the core portion formation step and the upper clad layer formation step described below.

(3) Formation of Core Portion

Next, as shown in FIG. 2(c), the composition for forming the core portion is applied onto the lower clad layer 13, and dried or further prebaked to form a thin film 14 for forming the core portion.

After that, as shown in FIG. 2(d), light 16 is preferably irradiated onto the upper surface of the thin film 14 for forming the core portion following a prescribed pattern, for example via a photomask 19 having a prescribed line pattern.

As a result, only parts irradiated with the light are cured, and hence by developing and removing the remaining uncured parts, as shown in FIG. 2(e), a core portion 15 comprising a patterned cured film can be formed on the lower clad layer 13.

Moreover, after the irradiation of the thin film 14 for forming a core portion for forming the core portion 15 with the light 16 has been carried out using the photomask 19 having the prescribed pattern, unexposed parts are developed using a developing solution, thus removing unwanted uncured parts, whereby the core portion 15 is formed.

The method of carrying out irradiation with light following a prescribed pattern in this way is not limited to a method using a photomask comprising parts through which the light can pass and parts through which the light cannot pass; examples of other methods are the following methods a to c.
a. A method using means for electrooptically forming a mask image comprising regions through which the light can pass and regions through which the light cannot pass following a prescribed pattern, using a similar principle to a liquid crystal display apparatus.
b. A method in which a light-guiding member comprising a bundle of many optical fibers is used, and irradiation with light is carried out via the optical fibers in accordance with a prescribed pattern in the light-guiding member.
c. A method in which laser light, or convergent light obtained using a converging optical system such as a lens or a mirror, is irradiated onto the composition while being scanned.

After the exposure, to promote the curing of the exposed parts, it is preferable to carry out heating treatment (hereinafter referred to as ‘PEB’). The heating conditions will vary with the composition of the optical waveguide-forming composition, the types of additives, and so on, but the temperature is generally 30 to 200° C., preferably 50 to 150° C.

On the other hand, before the exposure, merely by leaving the coating film comprising the optical waveguide-forming composition for 1 to 10 hours at room temperature, the shape of the core portion can be made to be semicircular. To obtain a semicircular core portion, it is thus preferable to leave for several hours at room temperature before the exposure in this way.

The thin film that has been selectively cured by exposing with light following a prescribed pattern as described above can be developed utilizing the difference in solubility between the cured parts and the uncured parts. After the patterned exposure, it is thus possible to remove the uncured parts while leaving behind the cured parts, and as a result form the core portion.

Here, as the developing solution, it is possible to use a solution obtained by diluting a basic substance such as sodium hydroxide, ammonia, ethylamine, diethylamine, tetramethylammonium hydroxide, tetraethylammonium hydroxide or choline with a solvent such as water, methanol, ethanol, propylene glycol monomethyl ether or acetone.

The concentration of the basic substance in the developing solution is generally made to be a value within a range of 0.05 to 25 wt %, preferably 0.1 to 3.0 wt %.

Moreover, the developing time is generally 30 to 600 seconds, and as the developing method, a publicly known method such as a liquid mounting method, a dipping method, or a showering developing method can be used.

In the case of using an organic solvent as the developing solution, blow drying is carried out as it is, or in the case of using an alkaline aqueous solution, washing in running water is carried out for, for example, 30 to 90 seconds, and then blow drying is carried out using compressed air, compressed nitrogen or the like, whereby moisture is removed from the surface, and hence a patterned coating film is formed.

Next, to cure the patterned parts furthermore, post-baking is carried out, for example, at a temperature of 30 to 400° C. for 5 to 60 minutes using a heating apparatus such as a hotplate or an oven, whereby a cured core portion is formed.

Moreover, in the case of adding an acid diffusion controlling agent to both the core layer and the clad layers, the content of the acid diffusion controlling agent is preferably set such that the concentration of the agent in the core layer is higher than that in the clad layers. However, in the case that it is not necessary to pattern the clad layers, the clad layers can be used without an acid diffusion controlling agent added thereto.

By adopting such a constitution, the pattern precision of the core portion can be further improved, and on the other hand for the compositions for forming the lower clad layer and the composition for forming the upper clad layer, excellent storage stability can be obtained, and moreover curing can be carried out sufficiently with a relatively low irradiation dose.

(4) Formation of Upper Clad Layer

Next, the composition for forming the upper clad layer is applied onto the surface of the lower clad layer 13 on which the core portion 15 has been formed, and is dried or prebaked to form an upper clad layer thin film. The upper clad layer thin film is then cured by being irradiated with light, whereby an upper clad layer 17 shown in FIG. 1 can be formed.

Moreover, the upper clad layer obtained through the irradiation is preferably further subjected to post-baking as described earlier as required. By carrying out post-baking, an upper clad layer having excellent thermal resistance and hardness can be obtained.

(5) Bonding on of Cover Member

The manufactured optical waveguide substrate is fixed on a spin coater, an adhesive is dripped onto the upper clad of the optical waveguide, the cover member is put on, and fixing with a jig is carried out such that the cover member does not shift out of position. Next, the optical waveguide substrate is rotated with the cover member thereon using the same procedure as with a spin coating method. By controlling the rotation speed and the time of rotation, a cover member-sealed optical waveguide substrate having a uniform adhesive layer can be obtained. All or a part of the surface of the upper clad layer may be covered with the cover member, but it is preferable for all of the surface of the upper clad layer to be covered with the cover member.

Following is a description of the present invention through working examples.

In the following examples, a silicon wafer was used as a substrate. Regarding the procedure for forming the optical waveguide, the procedure described earlier was followed. In the present examples, PJ5025 (made by JSR) was used as a radiation-curable composition for the lower clad layer and the upper clad layer, and PJ5024 (made by JSR) was used as a radiation-curable composition for the core layer. In Example 1 in Table 1, the clad layers were formed by heat curing. In the other Examples and Comparative Example, the clad layers were cured by photo-curing. For the core layer, a linear optical waveguide pattern was formed by exposing with light using a mask. The optical waveguide was formed such that the thickness of the lower clad layer was 15 μm, the thickness, the width, the length, and the inter-core spacing of the core layer was 8 μm, 8 μm, 6 cm and 20 μm respectively, and the thickness of the upper clad layer was 15 μm. Moreover, the compositions were designed such that the refractive index of the core layer was 1.003 times higher than the refractive index of the clad layers so as to design a single mode optical waveguide.

Evaluation

[Samples for Measuring Optical Characteristics]

A linear optical waveguide having an 8 μm×8 μm core manufactured on a 4-inch silicon wafer as an optical waveguide substrate for an optical device was prepared. Next, a 100 μm-thick glass plate was fixed onto the substrate using any of various adhesives, and dicing was carried out, thus samples having an optical waveguide length of 10 mm were manufactured.

[Change in Optical Characteristics Upon Cooling/Heating Shock Test]

After measuring the initial value of the insertion loss, the same sample was subjected to 500 cycles of cooling/heating treatment using a heat cycle of leaving for 30 minutes at −40° C. and then leaving for 30 minutes at 85° C., and then the insertion loss of the linear optical waveguide was measured, and the change in the insertion loss between before and after the cooling/heating treatment was determined. Samples for which the change in the insertion loss was 1 dB or more were taken as ‘×’, and samples for which the change in the insertion loss was within 1 dB were taken as ‘◯’.

[Change in Optical Characteristics Upon Constant-Temperature and Constant-Humidity Test]

After measuring the initial value of the insertion loss, the same sample was left for 2,000 hours in a constant-temperature and constant-humidity (temperature: 85° C., relative humidity: 85%) environment, and then the insertion loss of the linear optical waveguide was measured, and the change in the insertion loss between before and after the constant-temperature and constant-humidity treatment was determined. Samples for which the change in the insertion loss was 1 dB or more were taken as ‘×’, and samples for which the change in the insertion loss was within 1 dB were taken as ‘◯’.

TABLE 1

| | | Optical characteristics | | | | | |
|---|---|---|---|---|---|---|---|
| | | Cooling/heating shock test | | | Constant-temperature and constant-humidity test | | |
| Cover member | Type of adhesive | Initial value | After test | Judgment | Initial value | After test | Judgment |
| glass | UV acrylic | 1.0 | 1.5 | ◯ | 1.1 | 1.8 | ◯ |
| substrate | UV epoxy | 0.9 | 1.2 | ◯ | 1.0 | 1.4 | ◯ |
| thickness: | UV silicone | 1.0 | 1.4 | ◯ | 0.9 | 1.5 | ◯ |
| 100 μm | Amine-epoxy two liquid-type | 1.0 | 1.8 | ◯ | 1.2 | 1.8 | ◯ |
| | Heat-curable epoxy | 1.1 | 1.4 | ◯ | 1.0 | 1.6 | ◯ |
| None | None | 1.2 | 16.5 | X | 1.1 | 8.9 | X |

1-4. (canceled)

5. A polymer optical waveguide comprising:
a lower clad layer, a core layer, and an upper clad layer that are provided on a substrate, which further comprises a cover member that covers at least one part of upper clad layer,
wherein said lower clad layer, said core layer and said upper clad layer are each formed from a cured material of a radiation-curable composition, and said upper clad layer and said cover member are fixed together by interposing an adhesive layer comprising a radiation-curable adhesive between said upper clad layer and said cover member.

6. The polymer optical waveguide according to claim 5, wherein said cover member comprises a sheet of quartz or glass.

7. A method for manufacturing the polymer optical waveguide according to claim 5, the method comprising:
forming a lower clad layer, a core layer and an upper clad layer on a substrate using a radiation-curable composition;
dripping a radiation-curable adhesive onto said upper clad layer;
putting a cover member on said upper clad layer with said radiation-curable adhesive interposed therebetween, and fixing the cover member with a jig;
completing the polymer optical waveguide by irradiating said adhesive layer with a radiation.

8. The method of manufacturing the polymer optical waveguide according to claim 7, wherein said lower clad layer, said core layer, said upper clad layer and said adhesive layer are formed using a spin coating method.
